(19) United States
(12) Patent Application Publication
(10) Pub. No.: US 2009/0171534 A1
(43) Pub. Date: Jul. 2, 2009

(54) Method for Active Actuation of a Servo Valve Assembly

(75) Inventor: Markus Broecker, Grevenbroich (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: TRW AUTOMOTIVE GMBH, Alfdorf (DE)

(21) Appl. No.: 12/269,138

(22) Filed: Nov. 12, 2008

(30) Foreign Application Priority Data
Nov. 13, 2007 (DE) DE 102007054018.5

(51) Int. Cl. B62D 6/00

(52) U.S. Cl. 701/41

(57) ABSTRACT

A method for active actuation of a servo valve assembly in an electrohydraulic vehicle steering system includes the following method steps:
a) a steering-wheel angle and a steering wheel angular velocity are determined as input variables;
b) a pinion angle and a pinion angular velocity are determined as further input variables;
c) a setpoint is specified for the steering-wheel angle;
d) the input variables and the steering-wheel angle setpoint each are multiplied by an amplification parameter;
e) by summing the amplified input variables and the amplified steering-wheel angle setpoint, a control variable is determined for a servo valve actuator which actuates a valve component of the servo valve assembly;
f) the servo valve actuator is actuated corresponding to the control variable.

### CROSS-REFERENCE TO RELATED APPLICATIONS

This application claims priority to German Patent Application No. 10 2007 054 018.5 filed Nov. 13, 2007, the disclosures of which are incorporated herein by reference in their entirety.

### BACKGROUND OF THE INVENTION

The invention relates to a method for active actuation of a servo valve assembly in an electrohydraulic vehicle steering system.

Ordinary hydraulic or electrohydraulic vehicle steering systems (EHPS) designed as rack-and-pinion steering are not capable of performing an active control of the steering position when the steering wheel is released, as they principally only effect a rotation of the torsion bar in the case of a manual actuation of the steering wheel and hence generate an auxiliary force applied onto the rack.

In order to superimpose an assistance force determined by an electronic control unit, i.e. an additional steering torque, on the servo assistance force specified by the driver, German patent application DE 10 2006 055 279 A1 already describes a servo valve assembly which includes an electric torque superposition unit. The torque superposition unit constitutes a servo valve actuator and actuates a valve sleeve of the servo valve assembly, whereby a differential pressure is directly generated in the hydraulic cylinder chambers of the hydraulic or electrohydraulic steering system.

### BRIEF SUMMARY OF THE INVENTION

It is an object of the invention to actuate the torque superposition unit of a servo valve assembly with little effort such that when the steering wheel is released a desired steering angle of the steering wheel or of the steerable wheels is obtained.

According to the invention, a method for active actuation of a servo valve assembly in an electrohydraulic vehicle steering system comprises the following method steps:
a) a steering-wheel angle and a steering wheel angular velocity are determined as input variables;
b) a pinion angle and a pinion angular velocity are determined as further input variables;
c) a setpoint is specified for the steering-wheel angle;
d) the input variables and the setpoint for the steering-wheel angle each are multiplied by an amplification parameter;
e) by summing the amplified input variables and the amplified setpoint for the steering-wheel angle, a control variable is determined for a servo valve actuator which actuates a valve component of the servo valve assembly;
f) the servo valve actuator is actuated corresponding to the control variable.

The steering systems. It is preferably used in steering systems which constitute a rack-and-pinion steering and include a servo valve actuator, i.e. an electrically adjustable control unit for torque superposition. DE 10 2006 055 279 A1, to which reference is made expressly and to the fall extent, already discloses a servo valve assembly for a rack-and-pinion steering which comprises a servo valve actuator. In addition, rack-and-pinion steerings with servo assistance are generally known from the prior art, so that their construction will merely be discussed marginally for the precise The invention is based on a control technique method for trajectory control of a steering-wheel or driver angle when the steering wheel is released. The servo valve actuator actuates a valve component of the servo valve assembly, preferably the valve sleeve, and thus directly effects a differential pressure in the hydraulic cylinder chambers of the hydraulic or electrohydraulic steering system.

The method of the invention is used as a subordinate control circuit for employing parking and tracking aids in hydraulic or electrohydraulic vehicle definition of the used angles.

In servo-assisted rack-and-pinion steerings, a steering wheel generally is firmly connected with an input shaft of a servo valve, wherein the angle between the input shaft and a vehicle body-fixed housing is referred to as driver angle or steering-wheel angle and is defined to be 0° in a center position of the steering wheel. The valve input shaft is coupled with an output shaft or a pinion of the servo valve assembly (for instance via a torsion bar), wherein the pinion meshes with a rack which adjusts the steerable wheels of the vehicle. The angle between the pinion and the body-fixed housing is referred to as pinion angle and is defined to be 0° in a center position of the steerable wheels (straight-ahead driving).

In a vehicle steering with servo valve actuator in accordance with DE 10 2006 055 279 A1, it is a particularity that a valve sleeve of the valve assembly is not rigidly coupled with the output shaft or the pinion, but can be adjusted by the servo valve actuator. The angle adjusted by the servo valve actuator between valve sleeve and pinion is referred to as valve offset angle and corresponds to a motor angle of rotation in the case of a servo valve actuator constituting an electric motor in consideration of a transmission gear ratio. The aforementioned angles ultimately provide a so-called valve opening angle, which indicates the rotation between the valve input shaft and the valve sleeve. This angle determines the valve flow rate to working chambers of a hydraulic cylinder and hence the hydraulic steering force applied onto the rack or the steerable wheels.

In accordance with a preferred embodiment of the invention, the steering-wheel angle is obtained in step a) directly from sensor data. Nowadays, a steering-angle sensor for detecting the steering-wheel angle already is provided as a standard in many vehicles or can be retrofitted with little effort.

In step b), however, the pinion angle preferably is estimated indirectly via the steering-wheel angle and a measured manual torque. As mentioned above, numerous hydraulic or electrohydraulic servo steering systems already are equipped with a steering angle sensor. A steering torque sensor likewise is present in some embodiments or can be retrofitted with little effort, in order to represent the functionality in a suitable way. Thus, this indirect determination of the pinion angle involves no or only a minimum additional effort due to additional sensors.

The pinion angular velocity in step b) then can simply be determined by time derivation of the estimated pinion angle.

The amplification parameters of the input variables preferably are obtained by pole specification from a linear status feedback.

In accordance with a particular aspect of the invention, the setpoint for the steering-wheel angle is specified in step c) by means of a parking aid or tracking aid function and in step d) multiplied by the amplification parameter, wherein the amplification parameter is a controller parameter for precontrol.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows an electrohydraulic steering system with torque superposition in the combination driver/vehicle;

FIG. 2 shows a schematic representation of a vehicle steering system with a servo valve actuator for torque superposition; and

FIG. 3 shows a block circuit diagram of the control law for trajectory control of the steering-wheel angle when the steering wheel is released.

### DETAILED DESCRIPTION OF THE INVENTION

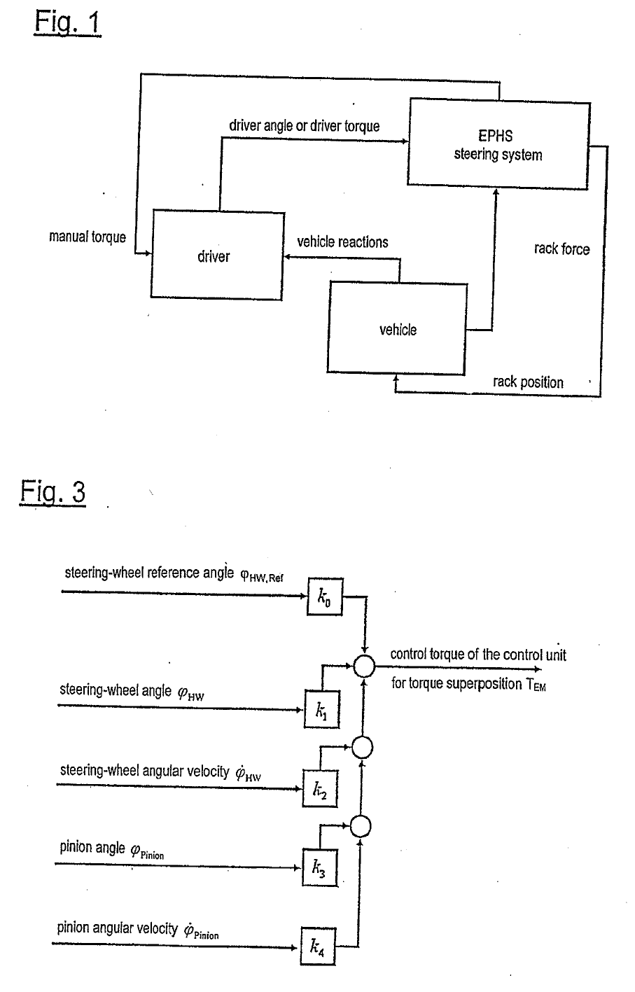

An electrohydraulic steering system with torque superposition can be illustrated in the combination driver/vehicle as shown in FIG. 1. Here, the physical input variables in the steering system are a driver angle or a driver torque and a rack force. Outputs of the steering system are a sensed manual torque and a rack position. In the following, the control path will be discussed, which consists of the electrohydraulic power-assisted steering system and a servo valve actuator.

For the released steering system (driver takes his hands from the steering wheel), a linear status model description can be formulated in a simplified way by:

\dot{x}=Ax+b₁u₁+b₂u₂ y=c^{T}x (1)

Here, u₁ is the first input, u₂ is the second input, y is the output, and x is the status vector. In the following, it will furthermore be assumed that the servo valve actuator for torque superposition comprises an electric motor and a transmission, in order to rotate the valve sleeve relative to the pinion.

The status vector then is given by:

x=[φ_{HW}\dot{φ}_{HW}x_{Rack}φ_{EM}\dot{φ}_{EM}]^{T} (2)

with the physical quantities steering-wheel angle HW steering wheel angular velocity \dot{φ}_{HW}, rack position x_{Rack}, rack velocity \dot{x}_{Rack}, and motor angle of rotation φ_{EM} and motor angular velocity \dot{φ}_{EM} (cf. FIG. 2).

The two inputs and the output are defined as:

u₁=F_{Assist}−F_{Reaction} u₂=T_{EM} y=x₁=φ_{HW} (3)

with a rack assistance force F_{Assist}, an external rack force F_{Reaction}, a control variable of the servo valve actuator, i.e. concretely a control torque T_{EM} of the electric motor and the steering-wheel angle φ_{HW}.

It is the advantage of this simplified description that two decoupled partial systems are provided, which only have an influence on each other due to the hydraulics, i.e. due to the generation of a rack assistance force F_{Assist} (cf. FIG. 2). The generation of the rack assistance force F_{Assist} is effected by actuating the electrohydraulic steering system and the servo valve actuator, thus via the physical quantities steering-wheel angle φ_{HW}, pinion angle φ_{Pinion} and valve offset angle φ_{VO}. A valve opening angle φ_{VS} of the servo valve assembly is obtained as:

φ_{VS}=φ_{XS}−φ_{Pinion}−φ_{XS}, (4)

from which the rack assistance force F_{Assis} is obtained as a function of the valve opening angle:

F_{Assist}=f(φ_{VS}). (5)

The pinion angle φ_{Pinion} or the pinion velocity dφ/dt are given by the pinion gear ratio iₚᵢₙᵢₒₙ:

φ_{Pinion}=x_{Rack}/i_{Pinion} (6a)

φ_{Pinion}=[dx_{Rack}/dt]/iₚᵢₙᵢₒₙ. (6b)

The system matrix according to equation (1) is given as:

$$\underline{\underline{A}} = [ \begin{matrix}[ - {c}_{TS} / {J}_{HW} ] & 1 & 0 & 0 & 0 \\ 0 & ( - {d}_{TS} + {d}_{HW} ) / {J}_{HW} & c / {J}_{HW} {i}_{Pinion} & {d}_{TS} / {J}_{HW} {i}_{Pinion} & 0 \\ 0 & 0 & 0 & 1 & 0 \\ [ {c}_{TS} / ( {m}_{Rack} {i}_{Pinion} ) ] & {d}_{TS} / {m}_{Rack} {i}_{Pinion} & - {c}_{ts /} {m}_{Rack} {i}_{Pinion} & - {d}_{TS /} {m}_{Rack} {i}_{Pinion} & 0 \\ 0 & 0 & 0 & 0 & 0 \\ 0 & 0 & 0 & 0 & - {c}_{EM} \\ & & & & {J}_{EM}\end{matrix} \qquad ( 7 )$$

and the input vectors and the output vector:

$${b}_{1} = [ \begin{matrix}0 \\ 0 \\ 0 \\ [ 1 / {m}_{Rack} ] \\ 0 \\ 0\end{matrix} ] , {b}_{2} = [ \begin{matrix}0 \\ 0 \\ 0 \\ 0 \\ 0 \\ 1 / {J}_{EM}\end{matrix} ] , {b}_{3} = [ \begin{matrix}1 \\ 0 \\ 0 \\ 0 \\ 0 \\ 0\end{matrix} ] . \qquad ( 8 )$$

The system parameters of the steering system with torque superposition are:
Torsion bar rigidity c_{TS} and torsion bar damping d_{TS},
steering wheel mass moment of inertia J_{HW} and steering wheel damping d_{HW},
rack mass m_{Rack} and pinion gear ratio i_{Pinion}, and
electric motor mass moment of inertia J_{EM}, motor rigidity] c_{EM} and motor damping d_{EM}.

To ensure that the two decoupled partial systems can be actuated, a new input v is introduced:

v=u₁ (9)

to which a linear status feedback is applied:

v=k₀y_{Ref}+k^{T}x=k₀y_{Ref}+k₁x₁=k₂x₂+k₃+k₄x₄. (10)

Here, y_{Ref}=φ_{HW, Ref}·y_{Ref} is the reference signal for the steering angle control, which is calculated as a control variable from superimposed parking aid function or superimposed tracling aid function. The controller parameter khd 0 is used for pre-control, and the further parameters k₁, k₂, k₃, k₄ are determined by pole specification of the status feedback. The control variable for the servo valve actuator, i.e. concretely the control torque T_{EM} for the electric motor, is calculated as:

T_{EM}=u₂≈i*v=k₀y_{Ref}+k^{T}x=k₀y_{Ref}+k₁x₁=k₂x₂+k₃k₄x₄. (11)

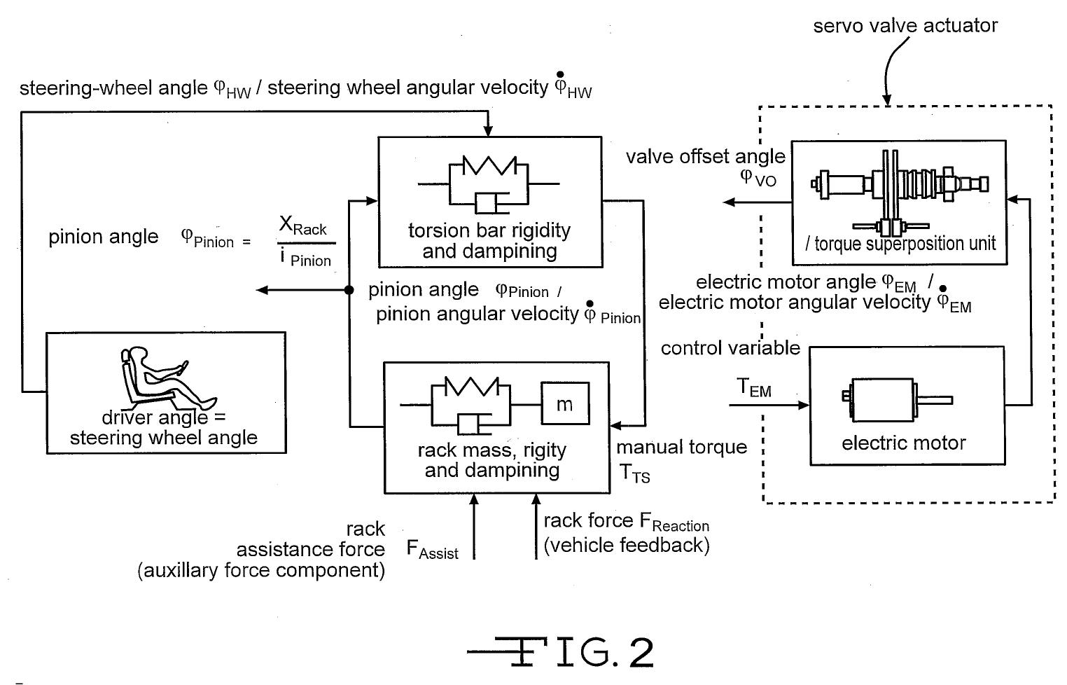

and is shown in FIG. 3. The mechanical gear ratio i* represents the transformation of a rack force into the electric motor control torque T_{EM}.

For the method of control technology for trajectory control of the steering-wheel angle φ_{HW}, the sensor signals steering-wheel angle φ_{HW} or steering wheel angular velocity \dot{φ}_{HW} are required:

x_{1,S}=φ_{HW} (12a)

x_{2,S}=\dot{φ}_{HW} (12b)

The calculation of the third and fourth status, i.e. the pinion angle φ_{Pinion} and the pinion angular velocity \dot{φ}_{Pinion} is effected by estimating with a measured manual torque T_{TS} (cf. FIG. 2) and with the measured quantities from equations (12a) and (12b):

$$\begin{matrix}{\tilde{x}}_{3} = {ϕ}_{Pinion} = {i}_{Pinion} ( {ϕ}_{HW} - \frac{{T}_{TS}}{{c}_{TS}} ) & ( 13 a ) \\ {\tilde{x}}_{4} = {\dot{ϕ}}_{Pinion} = \frac{d {\tilde{x}}_{3}}{d t} & ( 13 b )\end{matrix}$$

wherein the manual torque T_{TS} is determined with a steering torque sensor.

Inserted in equation (11), equations (12a) and (12b) and equations (13a) and (13b) provide:

T_{EM}=k₀y_{Ref}+k₁x_{1,s}+k₂x_{2,s}+k₃\tilde{x}₃+k₄\tilde{x}₄ (14)

This control law corresponds to the block circuit diagram of FIG. 3.

Proceeding from the setpoint specification φ_{HW,Ref} of a parking aid system or a tracking aid system, the control variable T_{EM} for the electric motor of the servo valve actuator is determined by means of the described method. With a corresponding actuation of the servo valve actuator, a valve component of the servo valve assembly (preferably the valve sleeve) is actuated such that by means of a resulting hydraulic assistance force on the rack the desired steering-wheel angle is obtained. This method can be used in particular for automatic or semiautomatic parking operations, in which the driver does not apply a manual torque, i.e. releases the steering wheel.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for active actuation of a servo valve assembly in an electrohydraulic vehicle steering system, the method comprising the following method steps:
a) a steering-wheel angle and a steering wheel angular velocity are determined as input variables;
b) a pinion angle and a pinion angular velocity are determined as further input variables;
c) a setpoint is specified for the steering-wheel angle;
d) the input variables and the steering-wheel angle setpoint each are multiplied by an amplification parameter;
e) by summing the amplified input variables and the amplified steering-wheel angle setpoint, a control variable is determined for a servo valve actuator which actuates a valve component of the servo valve assembly;
f) the servo valve actuator is actuated corresponding to the control variable.

2. The method according to claim 1, wherein in step a) the steering-wheel angle is obtained directly from sensor data.

3. The method according to claim 1, wherein in step b) the pinion angle is estimated indirectly via the steering-wheel angle and a measured manual torque.

4. The method according to claim 3, wherein in step b) the pinion angular velocity is determined by time derivation of the estimated pinion angle.

5. The method according to claim 1, wherein the amplification parameters of the input variables are obtained by pole specification from a linear status feedback.

6. The method according to claim 1, wherein in step c) the steering-wheel angle setpoint is specified by a parking aid function or a tracking aid function, and in step d) is multiplied by the amplification parameter, wherein the amplification parameter is a controller parameter for precontrol.
